(19) United States
(12) Patent Application Publication
(10) Pub. No.: US 2017/0019895 A1
(43) Pub. Date: Jan. 19, 2017

(54) SIGNALING METHOD FOR IMPROVED OFDMA-BASED DATA ACK/BA FRAME EXCHANGE IN WIRELESS NETWORK SYSTEMS

(71) Applicant: QUALCOMM Technologies International, Ltd., Cambridge (GB)

(72) Inventors: Naveen Kumar KAKANI, Coppell, TX (US); Sandipan KUNDU, Santa Clara, CA (US)

(21) Appl. No.: 14/802,784

(22) Filed: Jul. 17, 2015

(51) Int. Cl. H04W 72/04; H04L 5/00

(52) U.S. Cl. CPC H04W 72/0413; H04L 5/0007; H04L 5/0055; H04W 88/02

(57) ABSTRACT

The present invention relates generally to wireless networking, and more particularly to methods and apparatuses for increasing throughput of wireless devices and systems in a wireless network. The invention includes transmitting one or more signaling frames from one wireless device in the wireless network to other wireless devices (STAs) in the wireless network. The one or more signaling frames contain information concerning channel allocation for the transmission and requirement for the acknowledgement frames between the transmitting wireless device and the receiving wireless devices. This invention allows wireless devices not allocated the transmission medium to sleep during a transmission burst and different wireless devices allocated the transmission medium to be scheduled in different data transmission bursts.

### FIELD OF THE INVENTION

The present invention relates generally to mobile wireless networking, and more particularly to methods and apparatuses for improving OFDMA-based data transmission along with support for ACK/BA frame exchange in a wireless network system.

### BACKGROUND OF THE INVENTION

Orthogonal Frequency Division Multiple Access (OFDMA) as a modulation and multiple access technology has been shown to provide improvements in throughput when users (STAs) are allocated sub-carriers (or resource blocks) that provide better link conditions between the subscriber stations and base station (or Access Point).

Standard IEEE 802.16m is an OFDMA based solution. However, the technology was designed to be used in “Licensed Spectrum.” In other words, there is explicit downlink (DL) and uplink (UL) allocation of the spectrum because there are no legacy devices. This may result in some of the UL resources not being used effectively in a mobile wireless network system, legacy devices refers to 802.11 and other radio devices (e.g., BT and Zigbee) that are operating in the same band.

If the channel bandwidth is allocated to all the users (STAs in case of 802.11) equally, i.e., equal number of sub-carriers or resource blocks, it is possible that a portion of the BSS bandwidth allocated to some STAs is not used. For example, loss of data from an access point (AP) to an STA will cause the STA to not use the medium for uplink transmission even though the medium has been allocated to that STA. As another example, difference in the amount of data or difference in the link conditions between the AP and the STAs can result in portion of the bandwidth being not used. If a portion of the bandwidth is not used, a legacy device in the BSS or an OBSS may sense the medium to be idle and prematurely start using the wireless medium/channel/resource blocks.

Therefore, the existing methods cannot be used for allocation of resources in a wireless network where there are legacy devices (un-licensed spectrum). Accordingly there remains a need in the art for a solution to address the problems above among others.

### SUMMARY OF THE INVENTION

The invention discloses methods and apparatuses that address the problems discussed above by improving the signaling for the allocation of channel bandwidth and the management of scheduling for both downlink (AP to STA) and uplink (STA to AP) transmission. Specifically, the present invention discloses methods using new signaling frame, limiting the allowed frame exchanges, and allowing for new frames that STAs and AP are allowed to transmit on the medium using OFDMA.

Limiting the response from STAs to either ACK or BA frame allows for multiple bursts of OFDMA. Transmitting all the PPDUs with the same duration field as defined in the PHY header ensures that even if data is not received the duration of a PPDU is still conveyed accurately. Further, an NACK frame is introduced to explicitly signal to the transmitter of data that the last PPDU was not received. In the current IEEE 802.11, a transmitter may infer a loss of a data frame when there is no ACK frame from the intended receiver of the data frame. More importantly, this NACK frame is used to ensure that the medium is occupied so that no devices (legacy devices or STAs that have not been allocated the use of the medium in the current OFDMA burst) operating in the vicinity can improperly grab the medium. If a legacy device grabs the medium, the AP would need to perform a new channel access as the legacy devices' improper use of the medium breaks the whole OFDMA allocation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description of specific embodiments of the invention when read with the accompanied drawings in which:

FIG. 1 illustrates an example of a WLAN network with a BSS and an OBSS where embodiments of the invention can be applied.

FIG. 2 is a signaling frame structure according to an embodiment of the invention.

FIG. 3 is a flow chart illustrating an OFDMA burst transmission with DL data and UL ACK/BA and associated frame exchanges according to an embodiment of the invention.

FIG. 4 is a flow chart illustrating an OFDMA burst transmission with signaling frame used for DL data transmission and associated frame exchanges according to another embodiment of the invention.

FIG. 5 is a flow chart illustrating an OFDMA burst transmission with UL data from STAs to AP followed by DL ACK/BA from the AP to the STAs according to an embodiment of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention.

Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The basic service set (BSS) provides the basic building-block of an IEEE 802.11 wireless LAN. In infrastructure mode, a single access point (AP) together with all associated stations (STAs) is called a BSS. The access point acts as a master to control the stations within that BSS; the simplest BSS consists of one access point and one station.

Alternatively, under IEEE 802.11, an ad hoc network of client devices without a controlling access point can also be set up, such a network is called an IBSS (independent BSS).

OFDMA stands for Orthogonal Frequency Division Multiple Access. It is considered as a modulation and multiple access technique for next generation wireless networks for such as Mobile WiMAX and LTE. OFDMA is an extension of Orthogonal Frequency Division Multiplexing (OFDM), which is currently the underlying technology of choice for high speed data access systems such as IEEE 802.11a/g/n/ac wireless LAN (WiFi) and IEEE 802.16a/d/e/m wireless broadband access systems (WiMAX). In an OFDM system, only a single user can transmit on all of the subcarriers at any given time, and time division multiple access is employed to support multiple users. OFDMA, on the other hand, allows multiple users to transmit simultaneously on the different subcarriers per OFDM symbol. Hence it is often referred as Multiuser-OFDM.

IEEE 802.16e-2009 defines OFDMA Physical layer and MAC layer, popularly known as Mobile WiMAX. Mobile WiMAX is used for broadband data communication similar to cellular technologies. Base Station and Subscriber station devices available for Mobile WiMAX technology have been developed for different RF frequencies viz. 2.3-2.4 GHz, 2.5-2.7 GHz, 3.3-3.8 GHz as required for different countries spectrum allocations. Commonly used beam widths range from 1.25 MHz to 20 MHz in OFDMA. It supports FFT sizes of 128, 512, 1024 and 2048, but 512 and 1024 are commercialized by most of the equipment vendors and the same is certified by WiMAX Forum. The invention is also applicable to OFDMA transmission in other unlicensed bands like 900 MHz under the 802.11ah standard.

While the following detailed description may describe various embodiments of the present invention in relation to wireless networks utilizing orthogonal frequency division multiplexing (OFDM) modulation, the embodiments of present invention are not limited thereto and, for example, may be implemented using other modulation and/or coding schemes where suitably applicable.

Further, while example embodiments are described herein in relation to wireless local area networks (WLANs), the invention is not limited thereto and can be applied to other types of wireless networks where similar advantages may be obtained. Such networks specifically include, but are not limited to, WiMAX networks, wireless metropolitan area networks (WMANs), wireless personal area networks (WPANs), and/or wireless wide area networks (WWANs), sensor/IOT networks

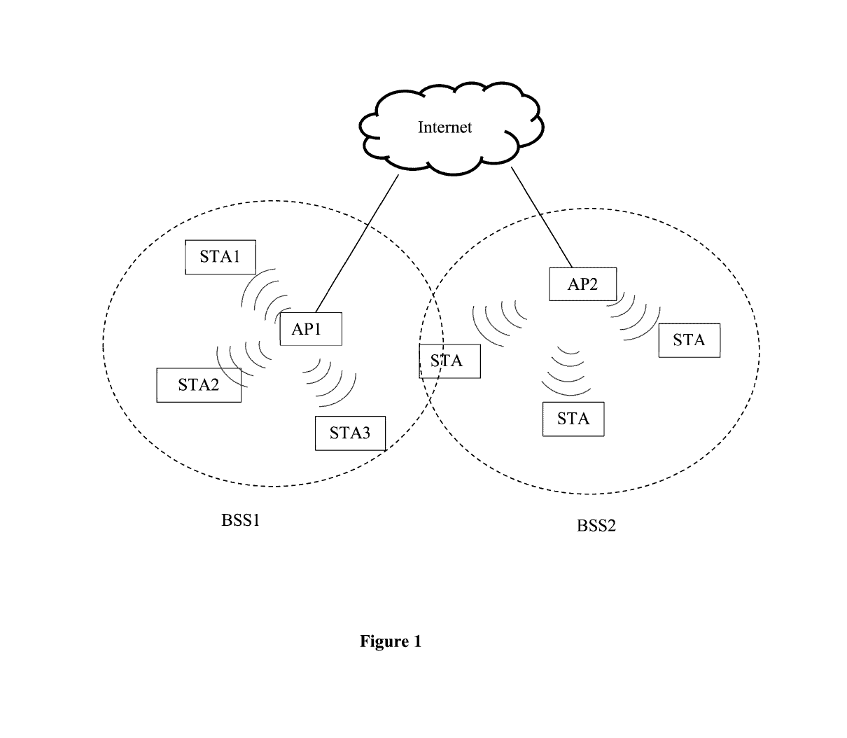

FIG. 1 is a diagram illustrating an exemplary WLAN environment with two BSS systems in which embodiments of the invention can be applied to facilitate and improve the scheduling management and bandwidth allocation of the wireless devices and the BSS systems.

The STAs in this example may include an entertainment device like an audio speaker, a video player, or a smart phone.

In FIG. 1, The APs are connected to Internet through wired lines or wireless network. The data transmission among the APs and the wireless devices (STAs) in the WLAN are OFDMA based. Before the actual transmission of an OFDMA starts, an AP station (AP1) sends signaling frame to the clients (STA1, STA2 and STA3) in the same BSS to set up and manage the medium allocation for the client devices. The client devices (e.g., STA1) send acknowledge frames to AP 1 for the data it eventually receives using the uplink channel. Also the AP can signal the medium allocation to each STA in the BSS, the STAs then send their data on the allocated resource block, and the AP in turn acknowledges the data it received from the STA(s) in DL.

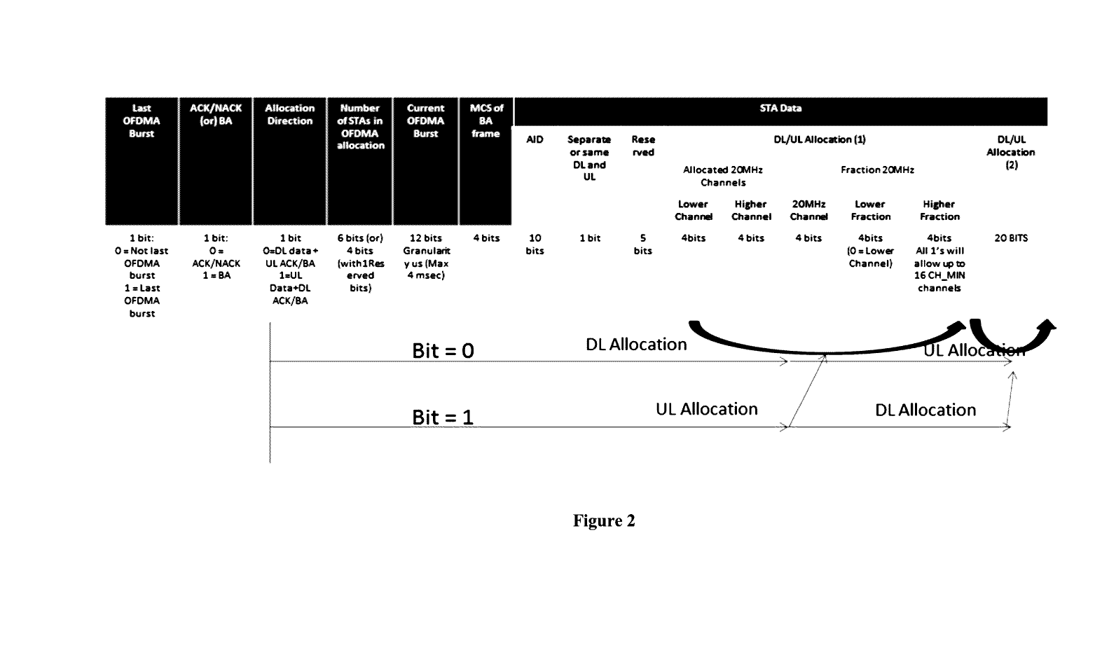

Turning to FIG. 2, which illustrates a 10-byte signaling frame 200 sent by an AP to the STAs in a BSS according to an embodiment of the present invention. Signaling frame 200 may be a separate MAC protocol frame or the content can be included in the Physical Layer Header portion of a MAC frame. As shown, frame 200 may include Last OFDMA Burst field, ACK/NACK or BA in UL field, Allocation Direction, Number of STAs in OFDMA allocation field, Current OFDMA Burst field, MCS of BA frame field and STA Data field. The signaling used to signal the scheduling and allocation of DL and UL resources to the STA are further described below.

Last OFDMA Burst field is a one bit field that signals whether there are additional OFDMA bursts following the current burst. If set to 1, AP signals to the STAs that this current burst is the last OFDMA burst. If set to 0, AP signals that there is additional burst to follow the current burst of data.

ACK/NACK or BA field is a one bit field that signals whether the response to the data is either ACK/NACK or BA. If set to 0, AP is signaling to the STAs that response to Data will require ACK/NACK frame. Otherwise, a BA acknowledgement frame is expected.

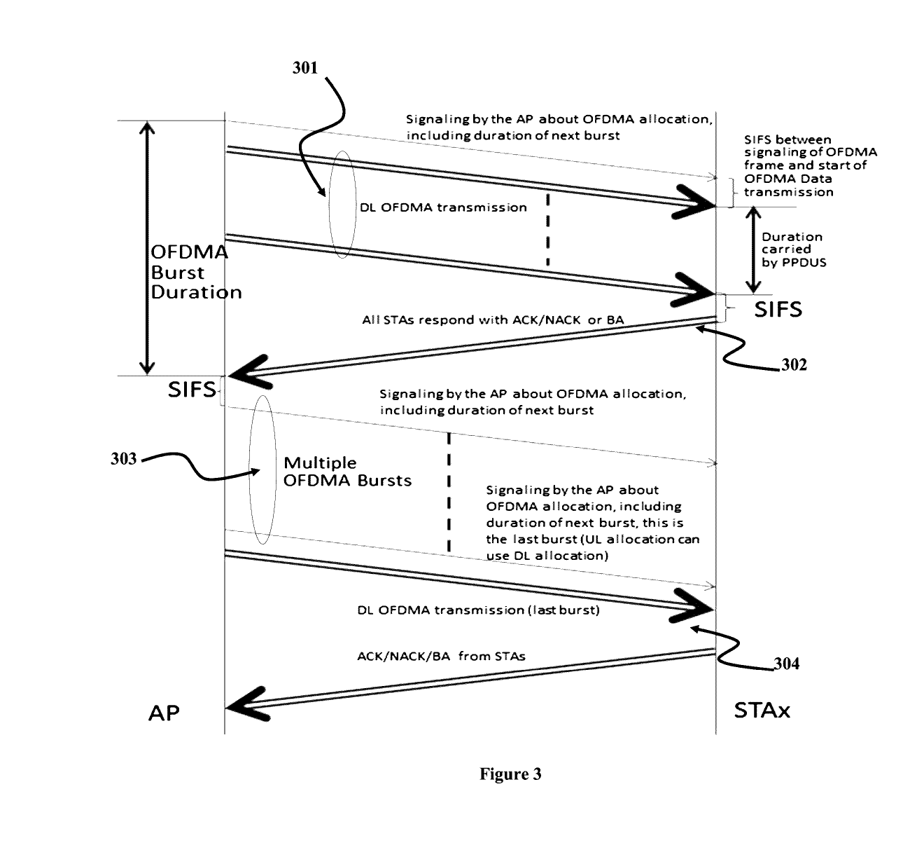

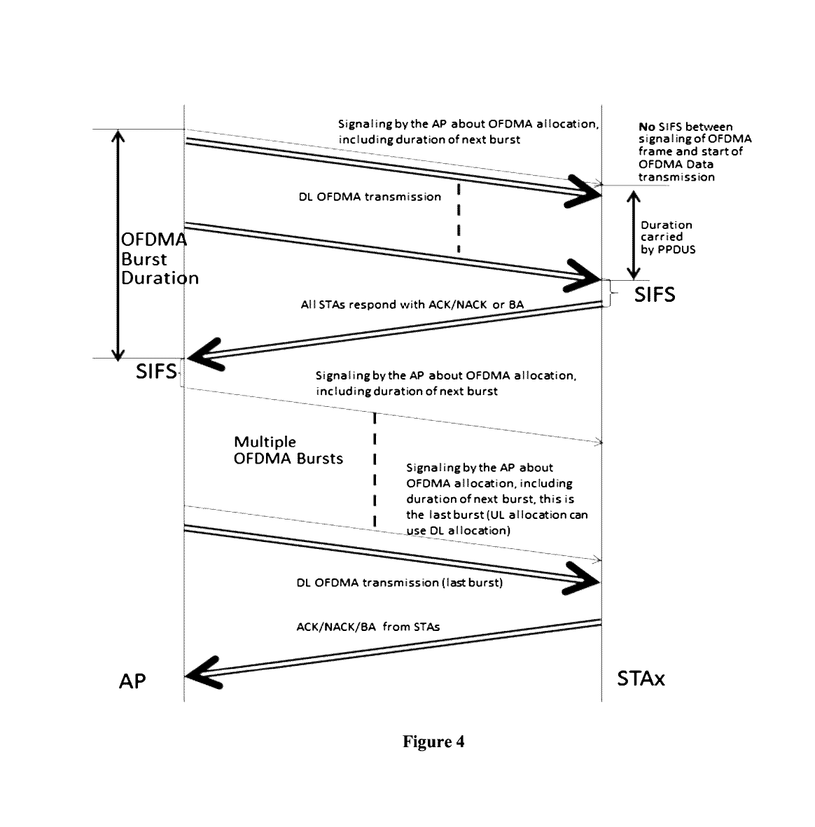

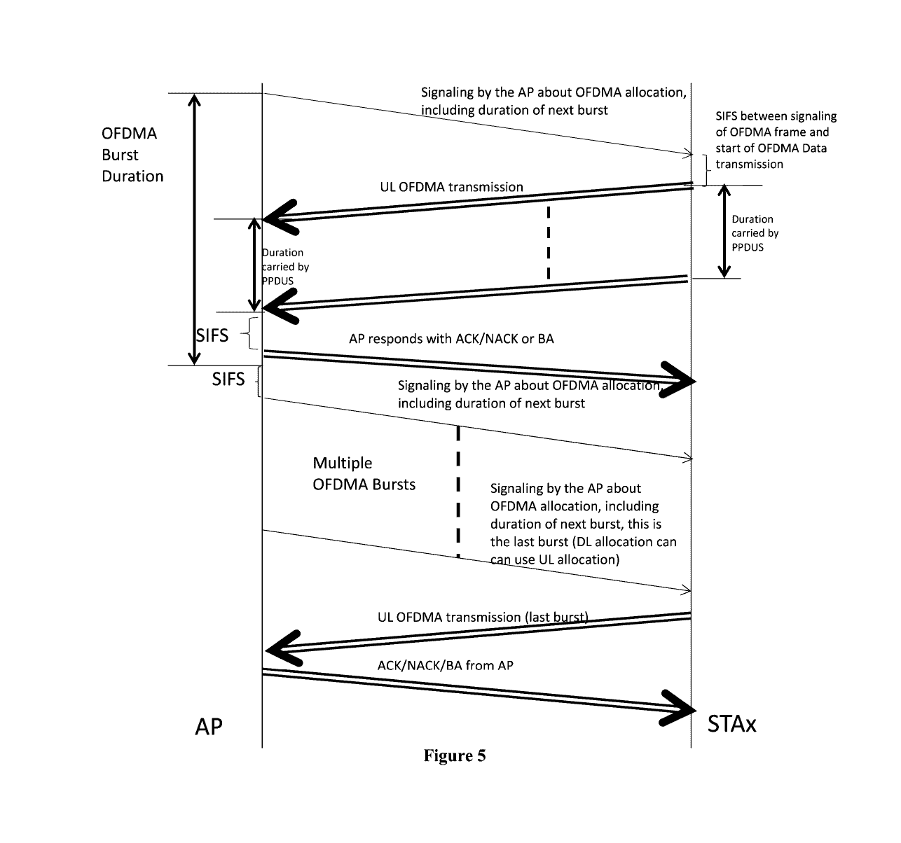

Allocation Direction field is a one bit field that signals the order of the UL and DL resource allocation in the STA Data field. For example, If Allocation Direction is set to 0, resource allocation for DL data transmission (DL/UL Allocation (1) field) is followed by resource allocation for UL ACK/BA transmission (DL/UL Allocation (2) field). The data transmission and the ensuing ACK/BA transmission is illustrated in FIGS. 3 and 4. If Allocation Direction is set to 1, resource allocation for UL Data transmission (DL/UL Allocation (1) field) is followed by resource allocation for DL ACK/BA transmission (DL/UL Allocation (2) field). The data transmission and the ensuing ACK/BA transmission is illustrated in FIG. 5.

Number of STAs in OFDMA allocation field is a 6-bit field that signals the number of STAs involved in the OFDMA burst. In this case, the maximum number of STAs involved in the OFDMA transmission can be 64. Alternatively, only 4 of the 6 bits are used to signal the number of STAs involved in the OFDMA burst and 2 bits are reserved bits.

Current OFDMA Burst field is a 12 bit field that signals the duration of the current burst. This duration is the time taken for the completion of PPDUs transmitted to all the STAs during the DL transmission along with the time required to send the ACK/NACK or BA for the DL data. The granularity of the allocation is of the order of microseconds (μs). This allows STAs that are not part of the current OFDMA allocation to go to sleep and wake up at the end of the current OFDMA burst.

MCS of BA frame field is a 4-bit field that is used in conjunction with the ACK/NACK or BA field. When ACK/NACK or BA field is set to 1, this MCS of BA frame field signals the modulation and coding scheme for the expected BA frame sent in response to the data. 4-bits MCS field can indicate 16 different MCS schemes. When ACK/NACK or BA field is set to 0, this field is considered reserved or not used.

The STA Data field is a 7-byte field that consists the following subfields: AID field, Separate or Same DL and UL field, Reserved field, DL Allocation field and UL Allocation field. These subfields are further described in the following paragraphs.

AID is a 10-bit field that defines the association ID of the STA that has been allocated UL and DL bandwidth for data transmission.

Separate or Same DL and UL field is a one bit field that signals whether the allocation of channels is the same for both DL and UL. If set to 0, it means that the allocation of DL and UL are separate. If set to 1, the same allocation for DL and UL.

DL Allocation field further consists of an 8-bit Allocated 20 MHz Channels field and a 12-bit Fraction 20 MHz field. The Allocated 20 MHz Channel field includes 4-bit Lower Channel subfield and a 4-bit Higher Channel subfield, indicating the allocated 20 MHz channel in terms of offset from the Primary Channel of the BSS. Generally, primary channel for a BSS is advertised in the Beacon frame.

For example, assuming the BSS is operating on Channel 0 to Channel 3 (each is a 20 MHz Channel i.e., a BSS operating at a bandwidth of 80 MHz), and if the primary channel is Channel 2, in this case if a particular STA is allocated Channel 1 to Channel 3 (i.e., three 20 MHz Channels) for data transmission the “Lower 20 MHz Channel” is signaled as “1001”, and the “Higher Channel” subfield signals “0001”.

The first bit (the left most bit) in “Lower Channel” subfield of “1001” i.e., “1’ indicates that this is a negative offset from the Primary Channel, and “001” indicates the number of Channels offset from the Primary. Since the primary channel is on Channel 2, “1001” indicates −1 Channel from the primary which is Channel 1.

The first bit (the left most bit) in “Higher Channel” subfield of “0001” i.e., “0” indicates that the Higher Channel is a positive offset from the Primary Channel. The rest of the bits “001” indicate the positive offset from the Primary channel is positive 1. Thus the higher channel is Channel 3 given that the Primary Channel is 2.

Alternatively, if the BSS is operating on Channels 52-64 (four 20 MHz Channels), then the Lower 20 MHz of the BSS is set as “0”, and the Lower Channel and Higher Channel indicate both the lower 20 MHz and Upper 20 MHz channel number of the allocation as positive integer value. Using the same example above and assuming an STA is allocated to operate on Channel 1 to Channel 3, then “Lower Channel” subfield will signal “0001” for “1” (Channel 1), and “Higher Channel” subfield will signal “0011” for “3” (Channel 3).

The 12-bit Fraction 20 MHz field further consists of a 4-bit 20 MHz Channel field, a 4-bit Lower Fraction field and a 4-bit Higher Fraction field. The 20 MHz Channel field contains the identifying number of the 20 MHz channel of which a fraction is allocated to the STA. The identifying 20 MHz channel number may be an offset from the primary 20 MHz channel or a channel number from the lower 20 MHz Channel of the BSS. As an example, if BSS is operating in Channels 52-64, the “lower 20 MHz channel of the BSS” would be Channel 52. The Lower Fraction field indicates the start CH_min (quantum) number of the 20 MHz channel identified and the Higher Fraction field indicates the last CH_min number. It is noted that CH_min may be separately signaled in different manners. For example, CH_min may be signaled in a Beacon frame of the AP, or indicated in the Signaling frame. Further, CH_min can be signaled specifically for each user. Examples of CH_min quantum may include 1.25 MHz, 2.5 MHz, 3.75 MHz and so on.

In some embodiment of the invention, “0” is the first CH_min (quantum) from the start of an 20 MHz channel of which a fraction of the 20 MHz channel is to be allocated. It is noted that if the CH_min quantum is 1.25 MHz, then 4 bits of the Lower Fraction and Higher Fraction subfields discussed above can be used to signal a total of 16 fractional bandwidth of a 20 MHz channel, as 20 MHz=16*1.25 MHz. If the CH_min is 2.5 MHz, then only 3 of the 4 bits of the Lower Fraction and Higher Fraction subfields will be used (8*2.5 MHz=20 MHz).

The following few paragraphs explains how the 20-bit of DL Allocation fields can be used for various channel allocation scenarios according to some embodiments of the present invention.

If an STA is allocated to a channel bandwidth that equals exactly to that of a CH_min, the 20 MHz Allocation Lower field, the 20 MHz Allocation Higher field, and the 20 MHz Channel field within Fraction 20 MHz field would all have the same value: the identifying number of the 20 MHz channel within which a fraction that equals a CH_min is allocated to the STA. The Lower Fraction and Higher Fraction subfields of the Fraction 20 MHz field would also have exactly the same value.

For example, assuming the CH_min is 1.25 MHz, and the primary 20 MHz starts at 2.6 GHz. If 20 MHz Channel field is 3 (both 20 MHz Allocation Lower field and 20 MHz Allocation Higher field are 3 too with the channel numbering starts from “0”, and the Lower Fraction and the Higher Fraction both equal to 5 with the fraction numbering starts from “0”, then the frequency allocated to the STA is from 2666.25 MHz to 2667.5 MHz, wherein the starting frequency and ending frequency are calculated as follows:

Starting Frequency=Primary 20 MHZ+3*20 MHz+5*CH_min=2.6 GHz+66.25 MHz

Ending Frequency=Starting Frequency+(Higher fraction−Lower fraction+1)*1.25 MHz=2.6 GHz+(5−3+1)*1.25 MHz

If an STA is allocated a bandwidth that is more than just a CH_min but still equal to a fraction of 20 MHz, then the 20 MHz Allocation Lower, 20 MHz Allocation Higher, and 20 MHz Channel field of the Fraction 20 MHz will also have the same value as discussed above. The Lower Fraction and the Higher Fraction subfields of the Fraction 20 MHz field will have the first CH_min and the last CH_min that are allocated to the STA, respectively.

Using the same example as above except that the allocated bandwidth is 3.75 MHz instead of 1.25 MHz. Assuming the Lower Fraction field has a value of 2, the Higher Fraction field would equal to 4 (as the allocated fractional BW is (Higher−Lower)+1)*CH_min, and 3.75 MHz=3*CH_min). Then the frequency allocated to the STA with a bandwidth of 3.75 MHz with a starting frequency of 2662.5 MHz and an ending frequency of 2666.25 MHz, wherein the staring frequency and ending frequency are determined as follows:

Starting Frequency=Primary 20 MHZ+3*20 MHz+(Lower fraction)*CH_min=2.6 GHz+3*20 MHz+2*1.25 MHz=2662.5 MHz

Ending Frequency=Primary 20 MHZ+3*20 MHz+(Higher fraction+1)*CH_min=2.6 GHz+3*20 MHz+5*1.25 MHz=Starting Frequency+3.75 MHz==2666.25 MHz.

If an STA is allocated to a bandwidth that is exactly 20 MHz, then the 20 MHz Allocation Lower field and 20 MHz Allocation Higher field will have the same value, where the identifying number corresponding to the allocated 20 MHz channel. The 20 MHz Channel subfield of the Fraction 20 MHz field will be set to all 1s, which is a reserved value. The Lower Fraction and the Higher Fraction subfields of the Fraction 20 MHz field are ignored/don't care. As such, the maximum bandwidth is 15*20 Mhz=300 MHz (the numbing starts from 0 and not from 1, so there are fifteen 20 MHz channels that can be represented when using 4 bits i.e., from 0000 to 1110 (0 to 14). However, if the full 20 MHz were to be allocated (instead of the fraction), 20 MHz Allocation Lower field=20 MHz Higher field=15 (the fraction is not allocated), in this case the maximum bandwidth is 16*20=320 MHz because all the numbers from 0-15 are valid.

Using the same example as above except that the 20 MHz Channel is now set to 1111, the frequency allocated to the STA with a bandwidth of 20 MHz is determined as follows:

Starting Frequency=Primary 20 MHZ+3*20 MHz=2660 MHz.

Ending Frequency=Primary 20 MHZ+3*20 MHz+20 MHz=2680 MHz.

If an STA is allocated to a bandwidth that is greater than 20 MHz, then the 20 MHz Allocation Lower field and 20 MHz Allocation Higher fields indicate respectively the first and the last complete 20 MHz Channels that are allocated. The 20 MHz Channel subfield of the Fraction 20 MHz field has the channel identifying number of the 20 MHz where the fractional bandwidth is allocated, with the Lower Fraction and the Higher Fraction subfields of the Fraction 20 MHz field respectively having the first CH_min and the last CH_min of the fractional bandwidth that is allocated to the STA.

It should be noted that the overhead for using a signaling frame (including both DL allocation fields and UL allocation fields) as discussed above is relatively insignificant for the data transmission in the WLAN (or WiMAX). The total number of overhead bytes for each STA is 7 bytes=16 bits+20 bits+20 bits. Given that a frame overheads=MAC Header 32 bytes+3 bytes=35 bytes, the total overhead for an OFDMA frame=35 bytes+7*Number of STAs in an OFDMA frame.

Assuming X bytes of data are being transmitted by each of the STA using the proposed OFDMA frame and with traditional WLAN frame, the overhead of the OFDMA frame transmitting at 9 Mbps is Preamble+35 bytes+7 bytes*Number of STAs=90+9*Number of STAs μs. The overhead with the existing WLAN frame transmitting at 6 Mbps is (90+SIFS)*Number of STAs μs.

In view of the above description, the signaling frame used by the AP to signal to the STAs during the OFDMA burst according to some embodiments of the invention are advantageous over the existing approaches and schemes currently used in today's wireless network applications. Specifically, using the signaling frame as described above or in a similar fashion offers at least the following benefits at a small cost (total overhead of the signaling frames is very small):
a. STAs which are not part of an OFDMA burst can sleep during the current OFDMA burst.
b. Different STAs may be scheduled in different OFDMA bursts.
c. In addition, some STAs may be set up for only ACK frames in the UL while some others may be set up for BA frames in the UL.

FIG. 3 illustrates an example of the OFDMA burst with DL data from an AP to STAs followed by UL ACK/BA from the STAs to the AP according to an embodiment of the invention. The following sections describe the behavior of the STAs and AP according to the signaling protocol discussed above.

### AP Behavior:

All the PPDUs for all the STAs in DL carry the same value in the PHY header for the Duration field, this corresponds to the longest value of the PPDU in the OFDMA burst.

During a burst that is not the last burst (301), if there is a STA included in DL allocation that is not set up for BA, then all the STAs in the current burst of a multiple bursts should be signaled to send only ACK/NACK for the current bust (302).

Further, all the STAs in UL are allocated the same amount of UL resources because the UL data is either an ACK/NACK frame or a BA frame. If a BA frame is required, the Modulation and Coding Scheme (MCS) of the BA frame is signaled assuming a 20 MHz BSS operation. If the STAs are allocated different amount of UL resources (e.g., different number of radio resources), then the data rate is scaled to ensure that the required transmission is completed before the end of the OFDMA frame.

When AP sends multiple OFDMA bursts to the STAs (303), the AP transmits a signaling frame to signal the channel allocation for the OFDMA downlink bursts for all the involved STAs, including duration of next burst, and whether this is the last burst.

If the current OFDMA burst is the last OFDMA burst (304), then the UL allocation to the STAs can be different for the STAs, i.e., all STAs need not send the same kind of frame in UL (ACK/NACK/BA). In other words, there is no need to align the completion of all UL transmissions at the same time. After the last OFDMA burst, an AP would be required to perform a new channel access. Thus it would not be an issue if legacy devices were to occupy the medium as a result of some of the UL transmissions are longer than the rest as there is no follow on OFDMA Burst.

### STAx Behavior:

If the current OFDMA burst in the DL is not the last burst, each STA is required to respond back in the UL either with an ACK/NACK frame or a BA frame to acknowledge the reception of the Data destined to the STA (302). Exactly for which specific acknowledgement frame is expected to be sent is signaled by the 1-bit ACK/NACK or BA in UL field in the signaling frame from AP to STAs as discussed above with respect to FIG. 2.

### NACK Frame

A STA sends a NACK frame to the AP if it is scheduled to receive data during an OFDMA burst (signaled apriori) but doesn't receive the data correctly during the OFDMA burst.

In one scenario, if the STA just receives the PHY header correctly (i.e., it would know the end of the DL PPDU), the STA will respond back with NACK/BA frame after the Duration of DL PPDU. If the ACK/NACK (or) BA field is set to “0” in the signaling frame according to an embodiment of the invention, the STA will respond with NACK frame. If the ACK/NACK (or) BA field is set to “1” in the signaling frame, the STA will respond with BA. The BA frame that is transmitted by the STA will acknowledge until the last successfully received Sequence Number of the MPDU. In other words, no matter whether data is received successfully or not, there is a BA frame transmission. Again, as discussed before, the MCS of the BA frame the STA uses is indicated in the Signaling frame.

In another scenario, if the STA is scheduled to receive data during an OFDMA burst (signaled apriori) and does receive the data correctly during the OFDMA burst, the STA will respond with an acknowledgement frame according to the setting of the ACK/NACK (or) BA field. Specifically, if the ACK/NACK (or) BA field of the Signal frame according to an embodiment of the invention is set to “0,” the STA will respond with an ACK frame. If the ACK/NACK (or) BA field is set to “1,” the STA will respond with a BA frame.

In yet another scenario when the current OFDMA burst is the last burst, the STA sends an ACK frame if it is expected to send an ACK/NACK frame and then the PPDU is received correctly. However, if the PPDU is received in error, the STA may or may not send a NACK frame.

In some embodiments of the invention, the content of the signaling frame can be included by the AP in the same OFDMA frame that includes content for different STAs as an OFDMA transmission (as shown in FIG. 4). AP first sends the preamble, then immediately follows with signaling frame content (PHY header has the signaling content) in OFDM format, followed by OFDMA transmission that includes data destined for each STA in the respective sub-carriers as allocated in the signaling frame content. The difference between this embodiment and the one shown in FIG. 3 is that there is no Inter Frame Spacing (SIFS) between the Signaling frame and the start of Data transmission and no additional preamble for the data transmitted (PHY Header). This aspect of the invention further improves the utilization of the medium.

If the expected response is a BA, then if there no MPDU's received in the current OFDMA burst that is also the last burst, the STA can choose not to send a BA frame.

FIG. 5 illustrates an example of the OFDMA burst with UL data from STAs to AP followed by DL ACK/BA from the AP to the STAs according to an embodiment of the invention. If UL data transmissions are done for different channel bandwidth, it is likely that the receiver i.e., the AP would be required to have multiple receivers to decode the preamble of all the UL STAs, this adds to the complexity of the implementation of an AP. To ensure that the benefits of UL OFDMA are fully explored but at the same time to reduce the complexity of the implementation of the AP, for UL Data or ACK/BA transmission the following can be considered as additional signaling options:
a. AP allocates UL resources to STAs in the BSS for their transmission in UL, but, it signals only one of the STAs that is scheduled to transmit data in the UL to transmit the header of the PPDU (PHY header). The STA selected to transmit the PHY header will transmit the PHY header over the entire BSS channel BW and not just in the resources allocated to the STA. All the STAs allocated to use the resources will start transmission on the medium right after the end of the transmission of PPDU header.
b. AP selects one of the STA allocated in a 20 MHz Channel to transmit the PHY header and the STA selected to transmit the PHY header will transmit the PHY header over the 20 MHz channel bandwidth and not just in the resources allocated to the STA.
c. AP allocates a group of STAs to use the medium in each 20 MHz Channel, i.e., the resource allocation is one or more 20 MHz, however, the STA is not allowed to use the medium for the entire OFDMA duration (STA is signaled the start time and amount of time that the STA can use the medium). Implicitly the start time can be signaled by signaling the sequence number of the STA i.e., if the sequence number is 3, then the start time will be the sum total of the medium time that STA with sequence number 1, and sequence number 2 are allowed to use the same channel (that is allocated to the STA). Instead of 20 MHz channel, the signaling can be for the entire BSS channel bandwidth (i.e., all STAs are required to transmit in the entire BSS) or a multiple of 20 MHz Bandwidth.

In the various embodiments discussed above, the “STA” device is typically any portable device (e.g. iPhone or similar smartphone, iPad or similar tablet computer, smart watch, laptop or notebook computer, etc.) that has built-in WiFi and/or Bluetooth transceiver capabilities such as those provided in chipsets and associated firmware from manufacturers. Those skilled in the art will be able to implement the STA functionality of the invention by adapting such chipsets and/or firmware after being taught by the present examples.

In the various embodiments discussed above, the “AP” device is either a standalone device (e.g. a device similar to a wired Access Point), a peripheral device (e.g. display screen) that has integrated AP functionality, or it can be a device such as a laptop/desktop that can allow an STA to be connected to it either by wired connection or wirelessly (e.g., WiFi Direct).

In some of the embodiments, AP functionality is implemented by chipsets and associated firmware from manufacturers. Those skilled in the art will be able to implement the principles of the invention by adapting such chipsets and/or firmware after being taught by the present examples.

The present invention that addresses the issues discussed above and various other issues will be described below in conjunction with embodiments compatible with standards such as those of the IEEE 802.11. However, the invention is not limited to these embodiments, and the principles of the invention can be extended to applications using other standards or proprietary or other wireless environments that primarily use medium sensing before transmitting on the medium, such as such as Bluetooth, Zigbee.

Furthermore, embodiments of the present invention may include or use a modified version of the frame structure as depicted in FIG. 2 for supporting lower latency operations, while maintaining backward compatibility, for example, to the IEEE Std 802.16-2009 specification frame structure. The frame structure as depicted in FIG. 2 may be used, for example, in the next generation of mobile WiMAX systems and devices (e.g., including the IEEE 802.16m standard). In some embodiments, frame 200 structure or portions thereof may be transparent to the legacy terminals (e.g., which operate according to mobile WiMAX profiles and IEEE Std 802.16-2009) and may be used only for communication between BSs, subscriber stations, and/or MSs that both operate based on the IEEE 802.16m standard.

The present invention is also applicable to MIMO wireless networks and to networks where there are multiple antennas at the AP and STA. Multiple antennas can be utilized to get diversity gain and/or spatial multiplexing gain. MIMO OFDMA systems can utilize the frequency, space, and time dimensions of a signal. As such, the invention can be utilized to address how OFDMA transmissions can be carried out in the presence of multiple antenna systems. For example the OFDMA frame can be used to indicate support for different modulation and coding scheme per spatial stream. Further, the invention can be used to signal allocation of medium time over different spatial streams as discussed above.

Additionally, the present invention is also applicable to full-duplex system, i.e., where the system are capable of simultaneous transmission and reception. OFDMA frame format can be used in both the transmission and reception. For example there is could two independent or dependent OFDMA frames for the full-duplex transmissions.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method for increasing throughput of wireless devices and systems in a wireless network, comprising:
transmitting one or more signaling frames from one wireless device (AP) in the wireless network to other wireless devices (STAs) in the wireless network, wherein the one or more signaling frames contain channel allocation information for the data transmission and requirement for acknowledgement frames between the AP and the STAs;
following transmission of the one or more signaling frames, transmitting data from the AP to the STAs in accordance with the allocation information contained in the one or more signaling frames; and
transmitting acknowledgement frames from at least one of the STAs to the AP based on the one or more signaling frames.

2. The method of claim 1, wherein the wireless network is OFDMA based.

3. The method of claim 2, wherein the one of more signaling frames contain one or more pieces of information in the group consisting of: whether to send an ACK/NACK frame or a BA frame from the STAs to the AP, the number of STAs in the OFDMA allocation, duration of current OFDMA burst, duration of the next OFDMA burst, whether a current OFDMA burst is the last OFDMA burst, allocation direction, the modulation and coding scheme of the BA frame, and the channel allocation for uplink and downlink transmission.

4. The method of claim 3, wherein the channel allocation includes one or more pieces of information in the group consisting of: the association ID of the STA that has been allocated uplink (UL) UL and/or downlink (DL) bandwidth for data transmission, whether the allocation of DL and/or UL for the STA is the same, number of channels of predetermined bandwidth allocated, and fraction of a complete channel of predetermined bandwidth allocated.

5. The method of claim 4, wherein the predetermined bandwidth is 20 MHz.

6. The method of claim 1, further comprising using different signaling frames for different STAs.

7. The method of claim 6, wherein the different signaling frames are transmitted in different OFDMA bursts.

8. The method of claim 1, wherein at least one of the STAs is configured to transmit only ACK frames to the AP.

9. The method of claim 1, wherein at least one of the STAs is configured to transmit BA frames to the AP.

10. The method of claim 1, wherein at least one of the one of more signaling frames is transmitted in a separate MAC protocol frame.

11. The method of claim 1, wherein the content of at least one signaling frame is included in the Physical Layer Header portion of a MAC frame.

12. The method of claim 2, wherein the transmitting data further comprising transmitting OFDMA bursts.

13. The method of claim 12, wherein the transmitting data further comprising the AP first transmitting the content of the one or more signaling frames in OFDM format immediately after the transmission of preamble, wherein the OFDMA transmission further includes data destined for each STA according to the content of the one or more signaling frames.

14. The method of claim 2, wherein an STA sends an acknowledgement frame to the AP according to the one or more signaling frames when the STA is scheduled to receive data but does not receive the data correctly during the data transmission.

15. A method for increasing throughput of wireless devices and systems in a wireless network, comprising:
transmitting one or more signaling frames from one wireless device (AP) in the wireless network to other wireless devices (STAs) in the wireless network, wherein the one or more signaling frames contain channel allocation information for the transmission and requirement for acknowledgement frames between the AP and the STAs;
following transmission of the one or more signaling frames, transmitting data from the STAs to the AP in accordance with the allocation information contained in the one or more signaling frames; and
transmitting acknowledgement frames from the AP to at least one of the STAs based on the one or more signaling frames.

16. The method of claim 15, wherein the wireless network is OFDMA based.

17. The method of claim 16, wherein the one of more signaling frames contain one or more pieces of information in the group consisting of: whether to send an ACK/NACK frame or a BA frame from the STAs to the AP, the number of STAs in the OFDMA allocation, duration of current OFDMA burst, duration of the next OFDMA burst, whether a current OFDMA burst is the last OFDMA burst, allocation direction, the modulation and coding scheme of the BA frame and the channel allocation for uplink and downlink transmission.

18. The method of claim 17, wherein the channel allocation includes one or more pieces of information in the group consisting of: the association ID of the STA that has been allocated uplink (UL) and downlink (DL) bandwidth for data transmission, whether the allocation of DL and UL for the STA is the same, number of channels of predetermined bandwidth allocated, and fraction of a complete channel of predetermined bandwidth allocated.

19. The method of claim 18, wherein the predetermined bandwidth is 20 MHz.

20. The method of claim 15, further comprising using different signaling frames for different STAs.

21. The method of claim 20, wherein the signaling frames are transmitted in different OFDMA bursts.

22. The method of claim 15, wherein at least one of the STAs is configured to transmit only ACK frames to the AP.

23. The method of claim 15, wherein at least one of the STAs is configured to transmit BA frames to the AP.

24. The method of claim 15, wherein at least one of the one of more signaling frames is transmitted in a separate MAC protocol frame.

25. The method of claim 15, wherein the content of at least one signaling frame is included in the Physical Layer Header portion of a MAC frame.

26. The method of claim 16, wherein the transmitting data further comprising transmitting OFDMA bursts.

27. The method of claim 26, wherein the transmitting data further comprising the AP first transmitting the content of the one or more signaling frames in OFDM format immediately after the transmission of preamble, wherein the OFDMA transmission further includes data destined for each STA according to the content of the one or more signaling frames.

28. The method of claim 16, wherein an STA sends an acknowledgement frame to the AP according to the one or more signaling frames when the STA is scheduled to receive data but does not receive the data correctly during the data transmission.
